(19) United States
(12) Patent Application Publication
(10) Pub. No.: US 2016/0273231 A1
(43) Pub. Date: Sep. 22, 2016

(54) NON-TOXIC, HIGHLY REPRESENTATIONAL VINYL FLOORING ARTICLE

(71) Applicant: Guodong Jiang, Milwaukee, WI (US)

(72) Inventor: Guodong Jiang, Milwaukee, WI (US)

(21) Appl. No.: 15/168,646

(22) Filed: May 31, 2016

Related U.S. Application Data
(63) Continuation-in-part of application No. 15/160,975, filed on May 20, 2016.
(60) Provisional application No. 62/333,030, filed on May 6, 2016.

(51) Int. Cl. E04F 15/10; E04F 15/02; G06F 17/50; C08J 9/00

(52) U.S. Cl. CPC E04F 15/107; C08J 9/0066; C08J 9/0014; C08J 9/0061; E04F 15/02038; G06F 17/50; C08J 2327/06; C08J 2455/02; G06F 2217/12

(57) ABSTRACT

The present invention is a non-toxic, highly representational vinyl flooring article made up of a high-strength substrate molecularly bonded to a variable texture pattern layer. The substrate is extruded from a vinyl composition of polyvinyl chloride (PVC), nanoscale particles of chemically synthesized calcium carbonate, foaming agent, PVC plasticizer, lubricant, toughening agent, and thermal stabilizer. None of the composition components are toxic. Once extruded, one surface of the substrate is heated to allow a molecular bond interface to form between the substrate and pattern layer. The variable texture pattern layer provides a highly representational and customizable surface appearance to the article.

### CROSS-REFERENCE TO RELATED APPLICATIONS

This patent application claims the benefit of U.S. Provisional Application No. 62/333,030 filed May 6, 2016. This application is a continuation-in-part and claims the benefit of U.S. patent application Ser. No. 15/160,975 filed May 20, 2016. The above applications are incorporated by reference herein in their entirety.

### FIELD OF INVENTION

This invention relates to the field of stock materials and more specifically to a non-toxic, highly representational vinyl article of manufacture that emulates the appearance and texture of multiple natural materials (e.g. wood and stone) without retooling of equipment.

### BACKGROUND OF THE INVENTION

Luxury Vinyl (LVT) is a type of flooring manufactured as tiles or planks that accounts for approximate 17.5 percent of all flooring sales in the U.S. Inventory levels (including domestic and imported shipments) exceed $1.2 billion a year. LVT is popular in both consumer and commercial markets. LVT is waterproof, easy to install, inexpensive, highly durable, and offers good acoustics.

According to industry standards, a product must comply with ISO Standard 14025 to be marketed as LVT. This standard teaches a formulation for high-density tiles that are no more than 5 mm thick. LVT is laminated and embossed to represent wood and stone.

There are several problems known in the art with respect to LVT that is compliant with ISO Standard 14025. First, the formulation can include potentially unsafe levels of specific toxins. Second, LVT products do not sufficiently represent the appearance of natural materials such as wood and stone, so that consumers will choose the product based upon an aesthetic preference as well as price. Consumers perceive other synthetic products that better emulate the look of natural materials as higher quality, justifying better price points than LVT.

Additionally, LVT testing poses an added burden for retailers. The level of known toxic substances must be monitored to ensure safe levels. Retailers face strong economic pressure to monitor potentially toxic substances, even those not currently regulated. When a regulated toxin is present in the product, retailers must assume the financial risk of continuously monitoring product shipments. Moreover, public perception of a product as unsafe, whether justified or not, can dramatically effect consumer demand.

For example, in 2016, the U.S. Consumer Products Safety Commission (CPSC) commissioned tests of flooring after the news show “60 Minutes” reported that flooring sold by a major retailer had higher levels of formaldehyde emissions than allowed by law. In 2015, the Home Depot U.S.A., Inc. publicized that it was voluntarily phasing out the use of orthophthalates. Researchers found that, of 65 vinyl flooring tiles tested, 38 (58 percent) contained orthophthalates. Orthophthalates are commonly found in flooring at levels exceeding CPSC's children's product standards. However, retailers, such as Home Depot, found it necessary to take a public stance rather than risk adverse public perception.

Although consumer initiatives have targeted orthophthalates and formaldehydes, other additives are being tested and are expected to be challenged by consumer groups. For example, a study by the non-profit group Heathy Building Network found tin and other heavy metals in 89% of LVT products offered. Although LVT manufacturers have developed substitutes for orthophthalates, the manufacturing and imaging processes require formaldehyde and other toxic substances, which must be constantly monitored to ensure that they do not exceed permissible levels.

In addition to safety considerations, the synthetic appearance of LVT influences consumers' choice of flooring. Consumers desire high quality representational products that convey the appearance and texture of natural products such as wood and stone. LVT has unrealistic repeating patterns and texture created by embossing plates that cannot adequately represent natural wood and stone.

There is an unmet need for a vinyl product that does not place consumers in daily contact with toxic substances, and which can be marketed and labeled accordingly.

There is a further unmet need for flooring fabrication methods that exclude any or all regulated toxins to simplify testing and minimize testing costs.

Finally, there is an unmet need for highly representational vinyl flooring products that replicate the look and texture of natural materials, such as wood and stone.

### BRIEF SUMMARY OF THE INVENTION

The present invention is a highly durable, representational, non-toxic flooring product, which combines a novel composition for the flooring substrate with a novel digital printing process. All processes are specific to the article produced. The vinyl composition is also used for a specific article of manufacture. A critical component of the composition is chemically synthesized or precipitated calcium carbonate (PCC) to control the durability and strength of the article as well as eliminate potential contamination by heavy metals. By forming the PCC chemically, instead of breaking down natural limestone, there is no risk that heavy metals can contaminate the composition. The composition includes polyvinyl chloride (PVC), nanoscale particles of chemically synthesized calcium carbonate, foaming agent, non-orthophthalate PVC plasticizer, lubricant, at least one non-PVC thermoplastic polymer as a toughening agent, and thermal stabilizer to form a high-strength substrate.

The substrate is extruded from the above composition to form multiple external surfaces, one of which is connected to the pattern layer by the molecular bond interface. The pattern layer provides a highly representational and customizable surface appearance to the article.

The manufacturing method is also specific to the article. This method chemically synthesizes nanoscale particles of calcium carbonate, combines them in the above composition, then extrudes and cools the above substrate. To form the molecular bond interface, the method heats one surface of the substrate and presses the pattern layer to the surface with a pressure application tool.

### BRIEF DESCRIPTION OF SEVERAL VIEWS OF THE DRAWING(S)

FIG. 1 illustrates a cross-section of an exemplary embodiment of a highly representational vinyl flooring article.

FIG. 2 illustrates a flowchart of a method for manufacturing an exemplary embodiment of a highly representational vinyl flooring article.

### TERMS OF ART

As used herein, the term “adhesive layer” means a continuous or non-continuous layer of an adhesive substance.

As used herein, the term “bound” means non-removably connected.

As used herein, the term “chemically synthesized” means produced through a chemical reaction.

As used herein, the term “digitally stored” means stored as data in an electronic storage device.

As used herein, the term “foaming agent” means any substance, when added in an effective amount, capable of creating pockets of gas in a polymer through a chemical or physical process.

As used herein, the term “molecular bond interface” means a layer formed by the thermal- and/or pressure-induced intermingling of molecules of two adjacent layers.

As used herein, the term “molecular bonding temperature” means a temperature that allows intermingling of molecules of two adjacent layers.

As used herein, the term “nanoscale particles” means solid particles that have an average diameter of approximately 1000 nm or less and are precipitated or otherwise synthetically formed.

As used herein, the term “orthorhombic” means a crystalline shape having three unequal axes at right angles.

As used herein, the term “precipitation reaction” means a chemical reaction that forms a solid substance using one or more fluid solutions.

As used herein, the term “prismatic” means a crystalline shape having bases or ends that are parallel, congruent polygons and sides that are parallelograms.

As used herein, the term “rhombohedral” means a crystalline shape having six faces, each faces being a rhombus.

As used herein, the term “scalenohedral” means a crystalline shape having 8 or 12 faces, each face being a triangle with three unequal sides.

As used herein, the term “texture” means any discernible surface characteristic such as, but not limited to, smooth, rough, striated, patterned, or granular.

As used herein, the term “thermal stabilizer” means any substance added to a polymer to increase the polymer's resistance to heat.

As used herein, the term “three-dimensional” or “multi-dimensional” means having a substantially non-flat or non-planar shape which may or may not be further characterized by curvature, angles, contours, grooves, protrusions, or other surfaces.

As used herein, the term “toughening agent” means any substance added in an effective amount to a polymer to increase the polymer's resistance to impact. Such substances may include, but are not limited to, polymers, natural products, synthesized products, or combinations thereof.

As used herein, the term “variable pattern texture layer” means a layer where material used to form an image is also used to create a texture.

### DETAILED DESCRIPTION OF THE INVENTION

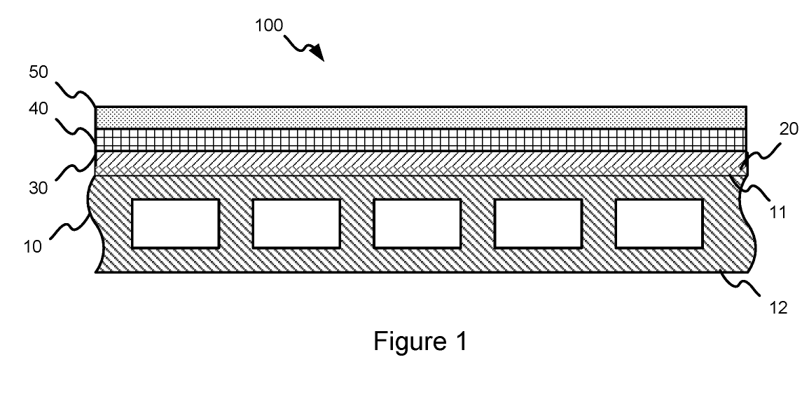

FIG. 1 illustrates a cross-section of an exemplary embodiment of highly representational vinyl flooring article 100. Highly representational vinyl flooring article 100 includes a high-strength substrate 10 with a variable texture pattern layer 30 connected by a molecular bond interface 20. An adhesive layer 40 connects variable texture pattern layer 30 to a coating 50. Highly representational vinyl flooring article 100 is inflammable, in that it does not support combustion when exposed to an open flame in the atmosphere, due to the inclusion of an effective amount of calcium carbonate, and may be formed in any configuration capable of being extruded.

High-strength substrate 10 includes multiple surfaces, including a first external surface 11 and a second external surface 12. Due to heat treatment and/or the bonding of variable texture pattern layer 30 via molecular bond interface 20, first external surface 11 is harder than second external surface 12. High-strength substrate 10 is extruded from a composition of polyvinyl chloride (PVC), nanoscale particles of chemically synthesized calcium carbonate, at least one foaming agent, at least one PVC plasticizer, at least one lubricant, at least one toughening agent, and at least one thermal stabilizer.

The nanoscale particles of chemically synthesized calcium carbonate have an average diameter of less than 1000 nm. In one embodiment, nanoscale particles of chemically synthesized calcium carbonate have an average diameter of between approximately 50 nm and approximately 500 nm. The nanoscale particles of calcium carbonate form by a chemical reaction, not by reduction from larger pieces or particles. This is critical, as chemically-produced calcium carbonate is more structurally uniform. This structural uniformity is found in a smaller, more consistent particle size, allowing for increased impact resistance of plastics it is added to. Chemically synthesized calcium carbonate also has a more consistent shape, giving more control over physical properties such as powder density, surface area, and particle absorption. The shape of the nanoscale particles of chemically synthesized calcium carbonate may include scalenohedral, rhombohedral, prismatic, or orthorhombic crystals. Producing calcium carbonate through a chemical reaction also allows increased purity and removal of potentially dangerous substances, such as heavy metals. In the exemplary embodiment, the nanoscale particles of chemically synthesized calcium carbonate form by a precipitation reaction.

In the exemplary embodiment, the composition includes between approximately 50 wt % and approximately 75 wt % of PVC, between approximately 25 wt % and approximately 30 wt % of nanoscale particles of chemically synthesized calcium carbonate, between approximately 1 wt % and approximately 2 wt % of foaming agent, between approximately 2 wt % and approximately 3 wt % of non-orthophthalate PVC plasticizer, approximately 1 wt % of lubricant, approximately 2 wt % of non-PVC thermoplastic polymer used as a toughening agent, and approximately 4 wt % of thermal stabilizer. In the exemplary embodiment, the non-orthophthalate PVC plasticizer is dioctyl terephthalate (DOTP). The lubricant is selected from a group consisting of: hydrocarbon-based lubricants and fatty acid-based lubricants. In the exemplary embodiment, the lubricant is paraffin. In the exemplary embodiment, the non-PVC thermoplastic polymer is acrylonitrile butadiene styrene (ABS), and the thermal stabilizer is calcium and zinc based. In certain embodiments, the composition also includes between approximately 1 wt % and approximately 2 wt % of stearic acid to protect against heat and cold damage, and reduce material oxidation. The composition does not contain orthophthalates, processing aids such as PVC-acrylic, or heavy metal-based stabilizers.

In certain embodiments, high-strength substrate 10 is a plank having at least two opposed edges with a tongue-and-groove configuration. In certain embodiments, high-strength substrate 10 has a significantly greater length than width or depth. In certain embodiments, high-strength substrate 10 includes at least one hollow chamber extending along a long axis or in extruded direction to reduce weight (as compared to conventional LVT). This reduction allows a better weight-to-volume ratio that may reduce shipping costs. In certain embodiments, first external surface 11 may be flat or three-dimensional.

Molecular bond interface 20 is formed by the thermal- and/or pressure-induced intermingling of first external surface 11 and variable texture pattern layer 30. This results in variable texture pattern layer 30 at least partially merging with first external surface 11, providing a strong bond between layers.

Variable texture pattern layer 30 is molecularly bonded to external surface 11 and is made up of any substance that can represent a computer-generated image or appearance. In the exemplary embodiment, variable texture pattern layer 30 is fabricated from at least one colored polymer. Variable texture pattern layer 30 may be a multi-colored pattern or a solid color. Any type of texture may be fabricated using a three-dimensional printer, reducing the equipment needed to produce highly representational vinyl flooring article 100.

Patterns used to fabricate variable texture pattern layer 30 may be digitally stored or generated, allowing a wide array of patterns mimicking stone, ceramic, wood, or any other building materials. In certain embodiments, the patterns are digital copies or photographs of existing building materials, such as, but not limited to, stone, ceramic, or wood. In other embodiments, the patterns are generated using computer software. Such embodiments may utilize a randomization algorithm during generation to prevent patterns from repeating over time, providing a more realistic appearance to highly representational vinyl flooring article 100.

Adhesive layer 40 joins coating 50 to variable texture pattern layer 30. Adhesive layer 40 is a transparent, waterproof, non-toxic adhesive. In the exemplary embodiment, adhesive layer 40 is a silicone-based adhesive.

Coating 50 is the transparent uppermost layer of highly representational vinyl flooring article 100 and is selected from the group consisting of aluminum oxide and urethane. Coating 50 prevents wear, oxidation, and ultraviolet (UV) damage of all remaining layers. Coating 50 may also impart a glossy, semi-gloss or matte finish to highly representational vinyl flooring article 100.

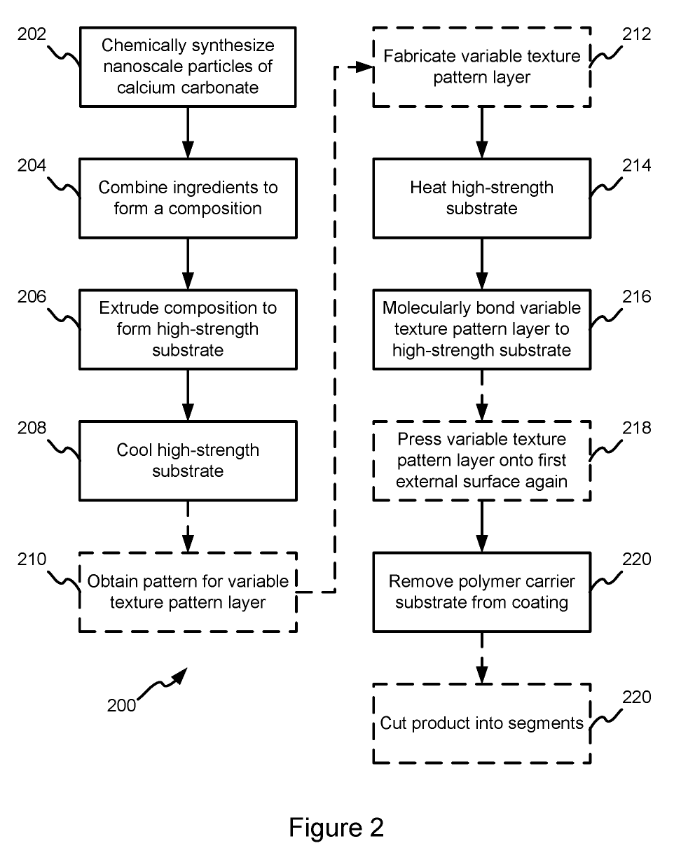

FIG. 2 illustrates a flowchart of a method 200 for manufacturing an exemplary embodiment of highly representational vinyl flooring article 100.

In step 202, method 200 chemically synthesizes nanoscale particles of calcium carbonate having an average diameter of less than 1000 nm. In the exemplary embodiment, this is a precipitation reaction. In one embodiment, the nanoscale particles of chemically synthesized calcium carbonate have an average diameter of between approximately 50 nm and approximately 500 nm. This step is critical to ensuring particles of the correct structure (i.e., size and shape).

In step 204, method 200 combines polyvinyl chloride (PVC), nanoscale particles of chemically synthesized calcium carbonate, at least one foaming agent, at least one PVC plasticizer, at least one lubricant, at least one polymeric impact toughening agent, and at least one thermal stabilizer to form a composition. One embodiment utilizes a hot-cold mixer to combine the ingredients at a high temperature to drive off any contaminants, and then continues to combine at a lower temperature in a controlled atmosphere to prevent recontamination.

In step 206, method 200 extrudes the composition to form high-strength substrate 10. The heat, pressure, and shear of the composition's passage through the extruder melts and combines the composition ingredients. In one embodiment, the extruder is a double-screw extruder. High-strength substrate 10 can be extruded as a flat sheet or three-dimensional cross-sectional shape. In one embodiment, high-strength substrate 10 has a tongue-and-groove cross-sectional shape. In another embodiment, high-strength substrate 10 has at least one hollow chamber extending along the direction of extrusion.

In step 208, method 200 cools high-strength substrate 10 to stabilize its shape and prevent deformation. In one embodiment, high-strength substrate 10 passes through a tank. In certain embodiments, this tank is filled with cold water.

In optional step 210, method 200 retrieves a digitally stored pattern. In certain embodiments, the digitally stored patterns are digital copies or photographs of existing building materials, such as, but not limited to, wood, stone, or other natural building materials. In other embodiments, the digitally stored patterns are generated using computer software. Such embodiments may utilize a randomization algorithm during generation to prevent patterns from repeating over time, providing a more realistic appearance to highly representational vinyl flooring article 100.

In optional step 212, method 200 fabricates variable texture pattern layer 30 on an upper surface of a carrier tape 60. Carrier tape 60 includes a polymer carrier substrate 61, coating 50, and adhesive layer 40. The surface of polymer carrier substrate 61 determines whether coating 50 will have a glossy, semi-gloss, or matte finish. After fabrication, variable texture pattern layer 30 is located on top of adhesive layer 40. In one embodiment, the polymer carrier substrate 61 is polyethylene terephthalate (PET). An exemplary embodiment of method 200 utilizes a three-dimensional printer, which may fabricate variable texture pattern layer 30 with any texture without requiring changes to the equipment.

In step 214, method 200 heats high-strength substrate 10 and/or carrier tape 60 to a molecular bonding temperature to create molecular bond interface 20 between high-strength substrate 10 and variable texture pattern layer 30. In the exemplary embodiment, this temperature ranges from approximately 100 degrees Celsius to approximately 200 degrees Celsius. Steps 214 and 216 may be performed simultaneously.

In step 216, method 200 molecularly bonds variable texture pattern layer 30 to high-strength substrate 10 using molecular bond interface 20. This is accomplished by pressing variable texture pattern layer 30 onto first external surface 11 using a heat transfer machine with a pressure application tool. In various embodiments, the pressure application tool is a solid mass of flexible material, a porous mass of flexible material, or a membrane of flexible material at least partially filled with fluid or a plurality of particles, such as beads or sand. In various embodiments, the pressure application tool may be deformed or inflated to conform to a surface. In the exemplary embodiment, the pressure application tool is a flexible, heat-resistant membrane at least partially filled with a fluid. The pressure application tool ensures that the machine applies uniform pressure to carrier tape 60 and first external surface 11, even with a three-dimensional high-strength substrate 10.

In optional step 218, method 200 again presses variable texture pattern layer 30 onto first external surface 11 using at least one other heat transfer machine. Method 200 may repeat step 216 until it produces a sufficiently strong molecular bond interface 20. The heat transfer machine(s) used for step 216 may have a rigid, deformable, or flexible pressure application tool.

In step 220, method 200 removes polymer carrier substrate 61 from coating 50.

In optional step 222, method 200 cuts highly representational vinyl flooring article 100 into segments of predetermined length and/or width.

It will be understood that many additional changes in the details, materials, procedures and arrangement of parts, which have been herein described and illustrated to explain the nature of the invention, may be made by those skilled in the art within the principle and scope of the invention as expressed in the appended claims.

It should be further understood that the drawings are not necessarily to scale; instead, emphasis has been placed upon illustrating the principles of the invention. Moreover, the terms “substantially” or “approximately” as used herein may be applied to modify any quantitative representation that could permissibly vary without resulting in a change in the basic function to which it is related.

What is claimed is:

1. A vinyl composition for a flooring article of manufacture comprised of:
polyvinyl chloride (PVC);
nanoscale particles of chemically synthesized calcium carbonate;
at least one foaming agent;
at least one non-orthophthalate PVC plasticizer;
at least one lubricant;
at least one non-PVC thermoplastic polymer as a toughening agent; and
at least one thermal stabilizer.

2. The vinyl composition of claim 1 wherein said composition comprises:
between approximately 50 wt % and approximately 75 wt % of said PVC,
between approximately 25 wt % and approximately 30 wt % of said nanoscale particles of chemically synthesized calcium carbonate,
between approximately 1 wt % and approximately 2 wt % of said at least one foaming agent,
between approximately 2 wt % and approximately 3 wt % of said at least one non-orthophthalate PVC plasticizer,
approximately 1 wt % of said at least one lubricant,
approximately 2 wt % of said at least one non-PVC thermoplastic polymer, and
approximately 4 wt % of said at least one thermal stabilizer.

3. The vinyl composition of claim 1 wherein said at least one non-orthophthalate PVC plasticizer is dioctyl terephthalate.

4. The vinyl composition of claim 1 wherein said at least one thermal stabilizer is calcium and zinc based.

5. The vinyl composition of claim 1 wherein said at least one lubricant is selected from a group consisting of: hydrocarbon-based lubricants and fatty acid-based lubricants.

6. The vinyl composition of claim 1 wherein said at least one lubricant is paraffin.

7. The vinyl composition of claim 1 wherein said at least one non-PVC thermoplastic polymer is acrylonitrile butadiene styrene (ABS).

8. The vinyl composition of claim 1 wherein said composition further includes between approximately 1 wt % and approximately 2 wt % of stearic acid.

9. The vinyl composition of claim 1 wherein said nanoscale particles of chemically synthesized calcium carbonate have an average diameter of between approximately 50 nm and approximately 500 nm.

10. The vinyl composition of claim 1 wherein said nanoscale particles of chemically synthesized calcium carbonate are precipitated nanoscale particles of chemically synthesized calcium carbonate.

11. The vinyl composition of claim 1 wherein said nanoscale particles of chemically synthesized calcium carbonate have a crystal shape selected from the group consisting of: scalenohedral, rhombohedral, prismatic, and orthorhombic.

12. A highly representational vinyl flooring article comprised of:
a high-strength substrate having at least a first external surface and a second external surface, wherein said high-strength substrate is extruded from a vinyl composition comprised of polyvinyl chloride (PVC), nanoscale particles of chemically synthesized calcium carbonate, at least one foaming agent, at least one non-orthophthalate PVC plasticizer, at least one lubricant, at least one non-PVC thermoplastic polymer as a toughening agent, and at least one thermal stabilizer; and
a molecular bond interface located between a variable texture pattern layer and said first external surface.

13. The article of claim 12 wherein said first external surface is harder than said second external surface due to heat treatment.

14. The article of claim 12, further including a transparent coating connected to said variable texture pattern layer, wherein said transparent coating is selected from the group consisting of aluminum oxide and urethane.

15. The article of claim 14 wherein said transparent coating is bound to said variable texture pattern layer by an adhesive layer.

16. The article of claim 15 wherein said adhesive layer is a silicone-based adhesive.

17. The article of claim 12 wherein said article contains an effective amount of calcium carbonate to render it inflammable.

18. The article of claim 12 wherein said high-strength substrate has at least one hollow chamber.

19. The article of claim 18 wherein said at least one hollow chamber extends along a long axis of said article.

20. The article of claim 12 wherein said high-strength substrate has the shape of a plank having at least two opposed edges, wherein said at least two opposed edges have a tongue-and-groove configuration.

21. A method of manufacturing a high-strength substrate for a highly representational vinyl flooring article comprised of the steps of:
(i). chemically synthesizing nanoscale particles of calcium carbonate;
(ii). preparing a composition comprising polyvinyl chloride (PVC), nanoscale particles of chemically synthesized calcium carbonate, at least one foaming agent, at least one non-orthophthalate PVC plasticizer, at least one lubricant, at least one non-PVC thermoplastic polymer as a toughening agent, and at least one thermal stabilizer;
(iii). extruding said composition to create a high-strength substrate; and
(iv). cooling said high-strength substrate.

22. The method of claim 21 wherein step (i) is a precipitation reaction.

23. The method of claim 21 wherein step (iii) extrudes said composition to include at least one hollow chamber in said high-strength substrate.

24. A method of manufacturing a highly representational vinyl flooring article comprised of the steps of:
(i). heating a high-strength substrate to a molecular bonding temperature; and
(ii). forming a molecular bond interface between a variable texture pattern layer and a first external surface of said high-strength substrate by applying pressure to said variable texture pattern layer and said first external surface with a pressure application tool.

25. The method of claim 24, which further includes the step of creating a variable texture pattern layer from a digitally stored pattern retrieved from electronic storage before step (ii).

26. The method of claim 25, which further includes the step of creating said digitally stored pattern with computer software before step (ii).

27. The method of claim 26, which further includes the step of performing a randomization algorithm to prevent patterns from repeating over time.

28. The method of claim 24, wherein said pressure application tool is a solid mass of deformable material.

29. The method of claim 24, wherein said pressure application tool is a porous mass of deformable material.

30. The method of claim 24, wherein said pressure application tool is a flexible membrane at least partially filled with at least one of a fluid or a plurality of particles.
